(19) United States
(12) Patent Application Publication
(10) Pub. No.: US 2009/0083289 A1
(43) Pub. Date: Mar. 26, 2009

(54) System For Accessing A Service Associated With A Resource

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/327,000

(22) Filed: Dec. 3, 2008

Related U.S. Application Data
(63) Continuation-in-part of application No. 10/996,668, filed on Nov. 24, 2004.

(51) Int. Cl. G06F 17/30

(52) U.S. Cl. 707/10; 707/E17.032

(57) ABSTRACT

A method and system for accessing services for any file or object that a user can retrieve through a browser. A service is associated with a web-accessible object based on a configurable matching condition, referred to as a service lock. Services are accessible for essentially any Web page or object that can be viewed in a browser. A service key is generated based on an attribute of a resource accessed via a uniform resource identifier. Service access information is located for accessing a service associated with the resource based on the service key matching a service lock for accessing the service. A service access message is generated, identifying the resource, based on the service access information and is sent for accessing the service.

### CROSS-REFERENCE TO RELATED APPLICATIONS

This application is a continuation-part of co-pending U.S. patent application Ser. No. 10/996,668, filed on Nov. 24, 2004, which is hereby incorporated by reference in its entirety.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

The present invention relates to services for multimedia objects, and more particularly to accessing services for multimedia objects.

Currently, images or other multimedia objects are provided on web sites with embedded metadata or associated services which a web browser or other application could make available to the user. However, several problems exist with the current way in which the metadata is managed or used or the associated service is accessed.

For example, stand-alone service web sites, a stand-alone web site used in conjunction with a client-side agent application and an application-specific browser extension are current ways that have problems. All of these service access tools require user knowledge that restricts the possible number of users.

### SUMMARY

Methods and systems are described for accessing services for any file or object that a user can retrieve through a browser. A service is associated with a web-accessible object based on a configurable matching condition, referred to as a service lock. Services are accessible for essentially any Web page or object that can be viewed in a browser. A service key is generated based on an attribute of a resource accessed via a uniform resource identifier. Service access information is located for accessing a service associated with the resource based on the service key matching a service lock for accessing the service. A service access message is generated, identifying the resource, based on the service access information and is sent for accessing the service.

### BRIEF DESCRIPTION OF THE FIGURES

FIG. 1 illustrates an embodiment of a system in accordance with the subject matter presented herein.

FIG. 2 is a flowchart of an embodiment of a method in accordance with the subject matter presented herein.

FIG. 3 illustrates a first implementation of the system in accordance with the subject matter presented herein.

FIG. 4 illustrates a second implementation of the system in accordance with the subject matter presented herein.

FIG. 5 is a flowchart illustrating an embodiment of a method for processing a service request in accordance with the subject matter presented herein.

FIGS. 6A-6B illustrate an example service profile.

FIG. 7 illustrates the display of an example web page by a browser in making a metadata service available in accordance with the subject matter presented herein.

FIG. 8 illustrates an embodiment of a system for providing the metadata service in accordance with the subject matter presented herein.

FIG. 9 is a flowchart illustrating an embodiment of a method for providing the metadata service in accordance with the subject matter presented herein.

FIG. 10 is a message flow diagram illustrating an embodiment of a method for accessing a service associated with a resource.

FIG. 11 is a flow chart illustrating an embodiment of a method for accessing a service associated with the resource.

### DETAILED DESCRIPTION

Presented is a method and system for automatically creating a metadata repository for multimedia objects. The following description is presented to enable one of ordinary skill in the art to make and use the subject matter and is provided in the context of a patent application and its requirements. Various modifications to the preferred embodiment will be readily apparent to those skilled in the art and the generic principles herein may be applied to other embodiments. Thus, the invention as claimed is not intended to be limited to the embodiment shown but is to be accorded the widest scope consistent with the principles and features described herein.

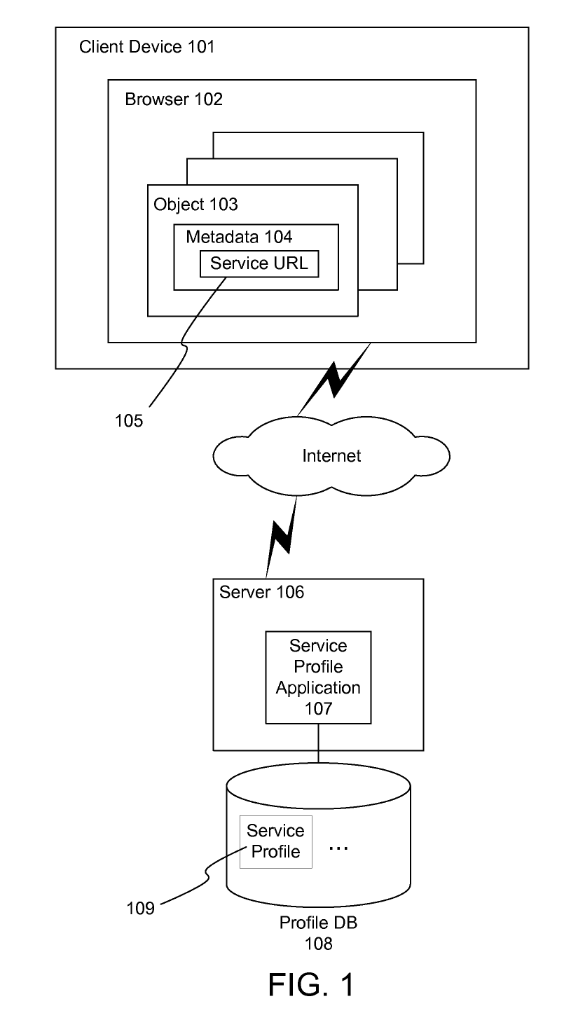

FIG. 1 illustrates an embodiment of a system in accordance with the present subject matter. The system includes a client device 101 capable of supporting a browser 102. The browser 102 is capable of displaying multimedia objects 103, such as images, audio, and video. The objects 103 have metadata 104 associated with them. The metadata 104 includes a service uniform resource locator (URL) 105, which references a server 106 where the browser can retrieve services available for the object 103. The server 106 includes a service profile application 107, which manages service profiles for various objects stored in a profile database 108. Each service profile 109 has one or more service descriptions, each of which identifies a service available to an object based on its identity, type, source, owner, or other attribute and how to access each service. A service specified in the service profile 109 is associated with a URL-accessible object based on a configurable matching condition (i.e., a service lock) included in the service profile.

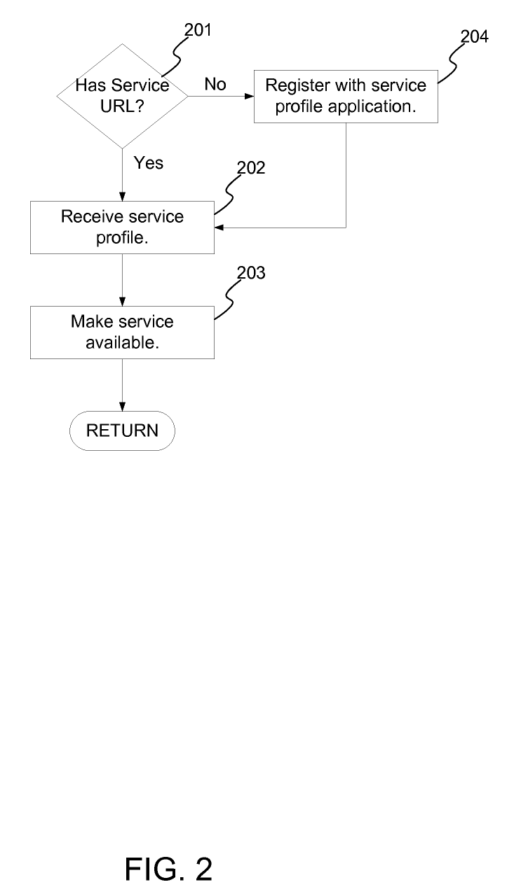

FIG. 2 is a flowchart of an embodiment of a method in accordance with the present subject matter. First, it is determined if the metadata 104 of an object 103 includes a service URL 105, via step 201. If no service URL 105 is associated with the object 103, then the object 103 is registered with the service profile application 107, via step 204. Upon registration, the service URL 105 to be associated with the object 103 is determined. For example, the context data and rules from the service profile application 107 or the client environment can be used to determine which services to make available and how they are to be presented. The browser 102 receives this service URL 105 and requests the originating application to store the object 103 with this service URL 105 in the profile database 108. This service URL 105 can then be used to obtain the service profile, via step 202. Once the service profile for the object 103 is received from the service profile application, the service described in the service profile is made available, via step 203. For example, a list of available services can be displayed in the context menu when the user right-clicks on the object 103. The user can then select one of the services listed. Additionally or alternatively, accessing the service(s) described in the service profile requires the service lock in the service profile to be unlocked by a service key. A service key is a set of attribute values that are provided by browser 102 and associated with the URL-accessible object 103 retrieved by the browser 102. Examples of attributes include an object's MIME-type, size, and source URL. When the service key matches the condition specified by the service lock of the service profile, the service profile “opens,” allowing access to the service description in the service profile.

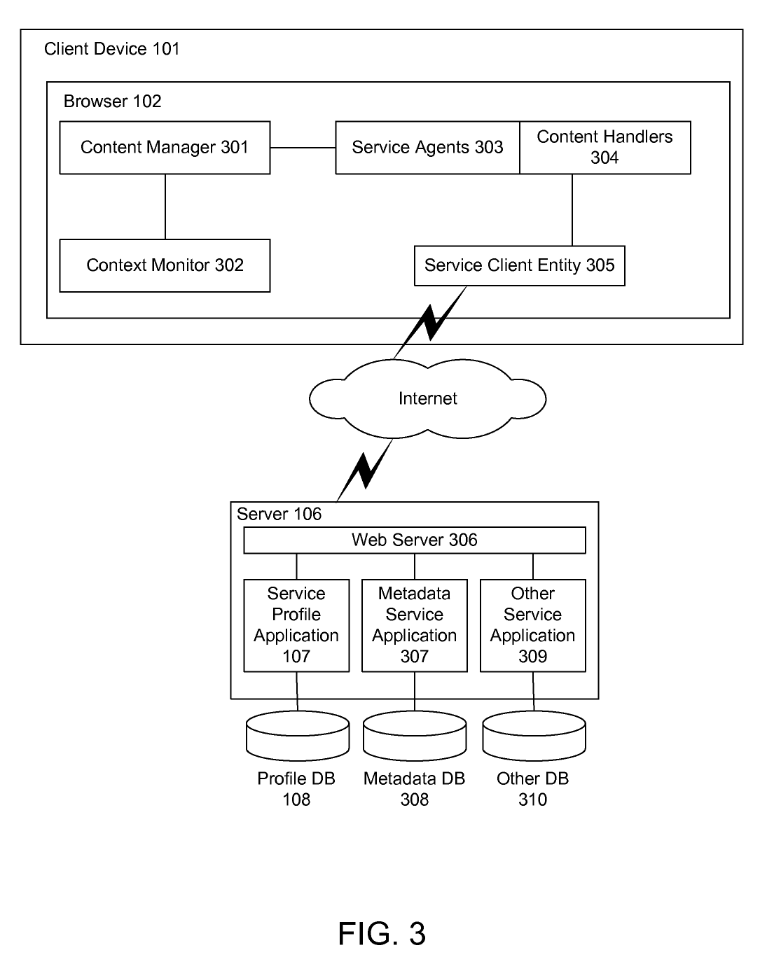

FIG. 3 illustrates a first implementation of the system. In this implementation, the browser 102 includes a content manager 301, a content handler 304 for each data type, and a service agent 303 associated with each content handler 304. The browser 102 further includes a service client entity 305 for facilitating communication between the service agents 303 and the server 106. The content manager 301 determines the type of data associated with the object 103 and routes the data to the content handler 304 associated with the data type. The service agents 303 are plug-ins for various data types and are associated with a content handler 304 for their data type. They intercept the data and calls from the content manager 301 to their associated content handler 304. The service agents 303 then ensures that the object 103 has a service URL 105, communicates with the service profile application 107 through the service client entity 305 using the service URL 105, processes the service profile received from the service profile application 107, and makes the services described in the service profile available through the browser 102. For example, the services may be made available to the user through an object's context menu.

At the server side, the system includes the server 106 that includes a web server 306 for managing various service applications. The services provided by the service applications are described in the service profiles stored in the profile database 108. These services can be invoked as set forth in the service profile.

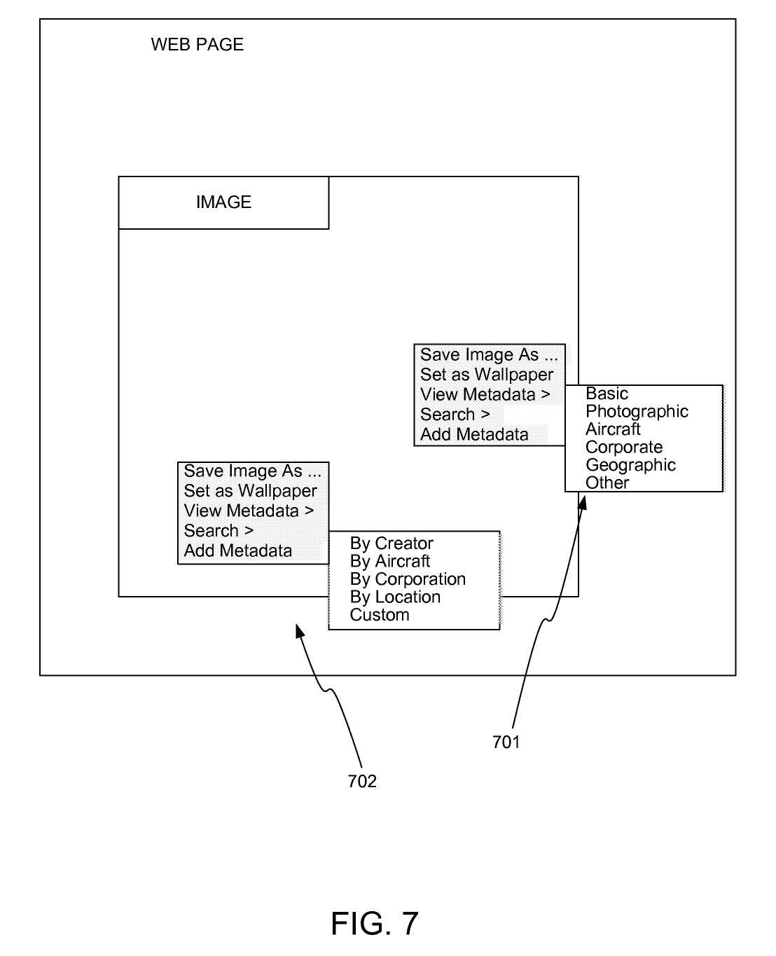

Optionally, the browser 102 can include a context monitor 302 for monitoring contextual information available from the user, the browser 102, the client device 101, or the data streams that the object 103 is associated with, such as an image in a web page. In the preferred embodiment, the context monitor 302 is used in providing the metadata service. A metadata service application 307 provides services for creating, modifying, and/or searching metadata in a database 308 associated with any URL identifiable object. The metadata service application 307 is described further later in this specification with reference to FIGS. 7-9. Any number of other service applications 309, with associated databases 310, is possible. Some example services include usage data collection, copyright enforcement, eCommerce, printing, and searching.

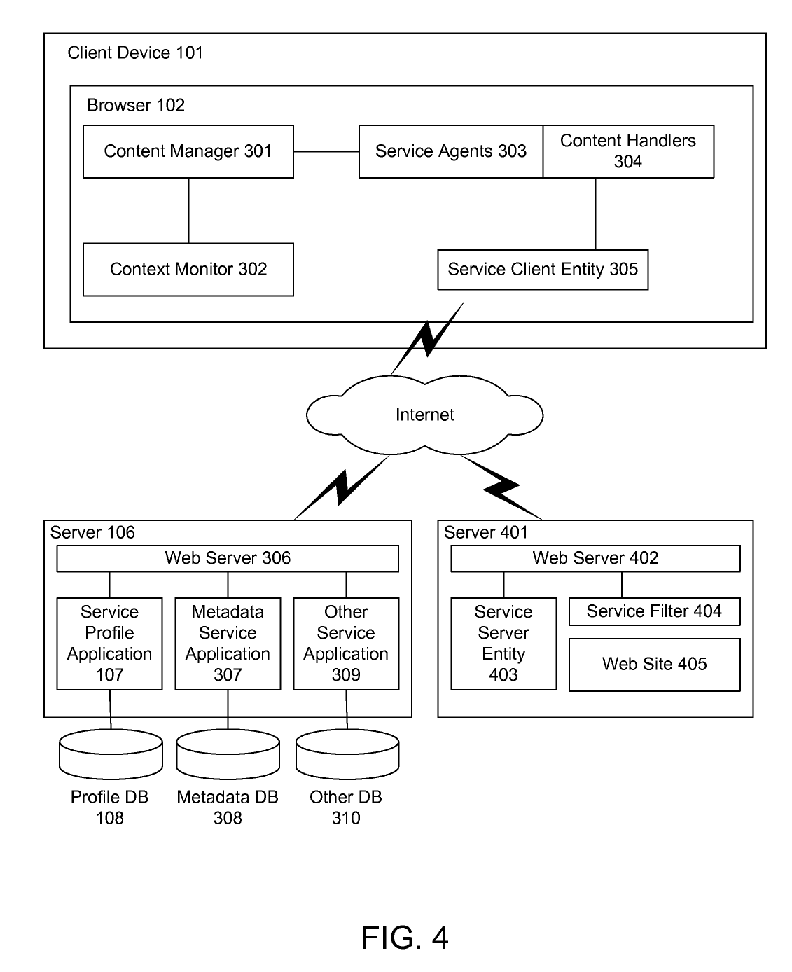

FIG. 4 illustrates a second implementation of the system. In this implementation, the server side further includes a server 401 that includes a web server 402 for managing a service server entity 403 and a service filter 404. Here, the service filter 404, rather than the service agents 303 at the client device 101, processes the object 103 before it is sent from the web site 405 to the browser 102 and ensures that it is associated with a service URL 105. It may provide access to any supported services. The service server entity 403 enables the service profile application 107 and the service filter 404 to communicate.

The service URL may be associated with an object in several ways. For example, the object can carry with it an identifier for where additional services are located. Alternatively, the client device 101 can apply a default service URL associated with various elements of a web page. The client device 101 then asks for this service URL to be inserted into the object. Other mechanisms are possible, such as matching the source URL of an object to another URL, where the other URL is the service URL.

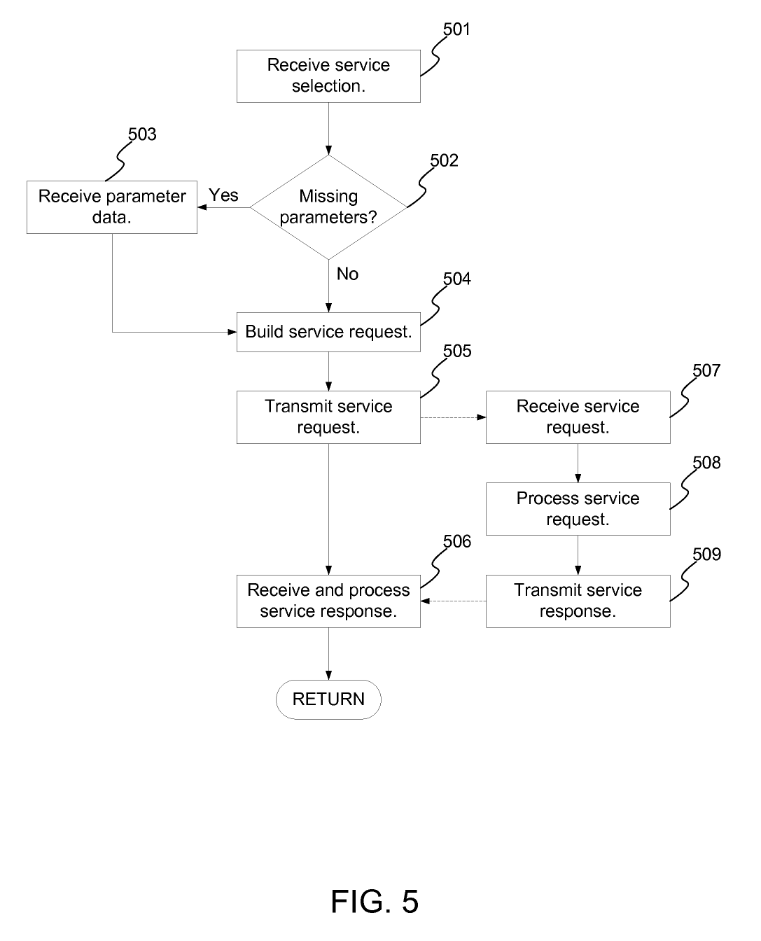

FIG. 5 is a flowchart illustrating an embodiment of a method for processing a service request in accordance with the present subject matter. Once a service selection is received by the appropriate service agent 303, via step 501, it is determined if any parameters are missing, via step 502. If so, then information that can be gained from the object or its context can be used to fill in the missing parameters. For example, an image's type, file size, and source can be gained from the image itself. If any parameters cannot be obtained in this manner, then the user can be prompted for the missing information. Once the parameter data is received, via step 503, the service agent 303 builds the service request, via step 504, using the service descriptor template from the service profile. The service agent 303 then transmits the request to a specified service application at the server 106, via step 505.

Once the server application receives the service request, via step 507, it processes the service request, via step 508, and transmits the service response back to the client device 101, via step 509. The client device 101 receives and processes the service response, via step 506.

For example, while browsing a web site on airplanes, Ima Pilot, sees an image of an L1011 which she used to fly before she retired. She wants more information about the particular aircraft in the image. Her browser supports a service agent which has access to every image retrieved. The browser found no service URL in the image stream. The service agent contacts the default service and provides the source URL for the image. The service finds an entry for the provided URL and returns an indication to the service agent that service is available for this image.

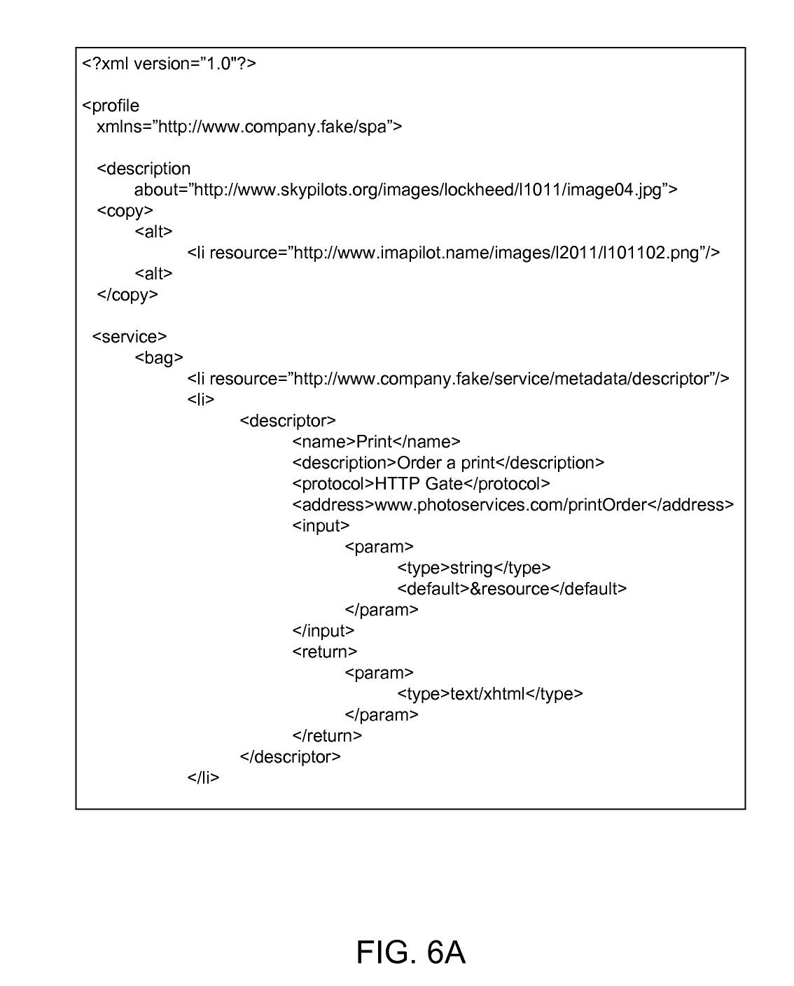

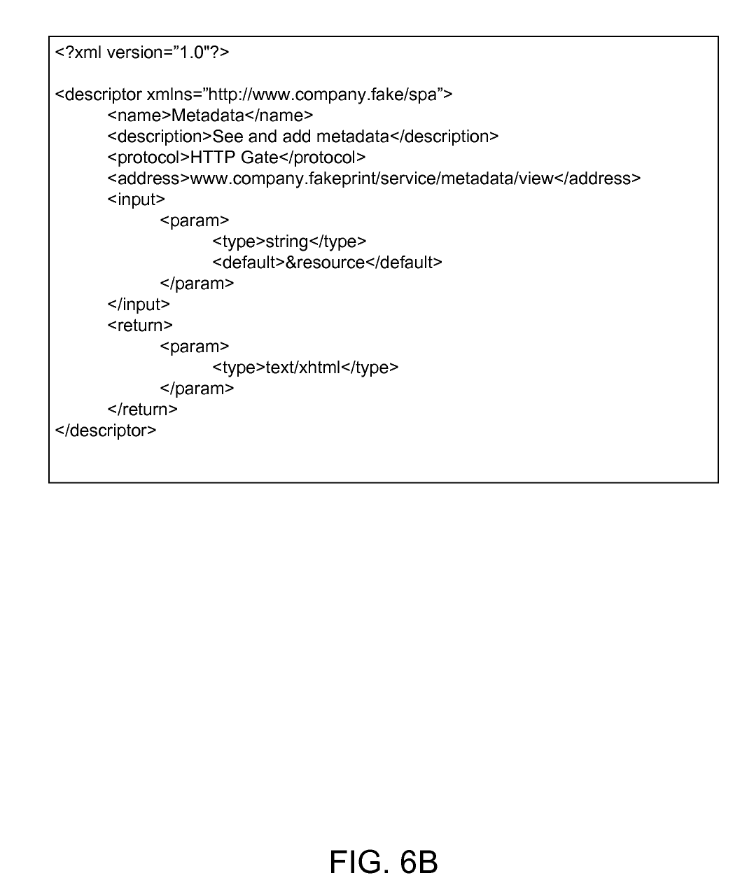

Ms. Pilot right-clicks the image to display the context menu. The service agent retrieves the service profile for the image and uses it to add entries for the available services in the context menu. FIGS. 6A-6B illustrate an example service profile. The profile includes a description of the image, including its source URL, and a description of the service available for the image, such as a print service (FIG. 6A) or a metadata service (FIG. 6B). Included in the service description is any input parameter descriptors associated with the service.

Assume that the context menu items inserted are: “view metadata” with a submenu showing the various vocabularies available (“photographic”, “print”, “image content”, “ownership”, etc.); “Get a copy of the original”; “Get a print”; and “Create new metadata”. Assume that Ms. Pilot opts to view the metadata associated with the image. The browser builds the service request, transmits it to the server, and processes the service responses. In this example, the service agent redirects Ms. Pilot to a web page showing only the identifier for the plane, the location where the image was captured, and the date. Ms. Pilot decides to add information by selecting “Create new metadata”. Ms. Pilot is taken to a web page where she is guided through the available vocabularies she can use. Optionally, Ms. Pilot can create her own vocabulary. She provides all the information she knows about the history of the plane using a vocabulary created for flying machines and the characteristics of the plane.

Later, anyone accessing a copy of this image may retrieve the information Ms. Pilot provided. As copies of the image are registered with the service, the information about the copies is added as metadata. Any metadata in any of the image files retrieved is pulled out and added. For example, assume that Ms. Pilot requests a copy of the original. The service agent sends the request to the service. The service looks up the source URL for the original and makes a request for the original on Ms. Pilot's behalf. If payment is required, Ms. Pilot is redirected to a payment page. The original is retrieved and saved on Ms. Pilot's hard drive. Then, Ms. Pilot can edit the image and send it others. Her photo-editing software creates a new record in the repository for the altered copy with a reference to the original as part of the new image's metadata.

FIG. 7 illustrates the display of an example web page by a browser in making a metadata service available. When a user right-clicks on the image of the Air France plane, a context menu is displayed. The context menu includes a list of available services for the image, as described in the image's service profile. Two example context menus are illustrated. In the context menu 701, the list includes “Save image as . . . ”, “Set as wallpaper”, “View Metadata”, “Search”, and “Add Metadata”. The “View Metadata” service includes a sub-menu listing available metadata vocabularies: “Basic”, “Photographic”, “Aircraft”, “Corporate”, “Geographic”, and “Other. The “Basic” vocabulary could include information such as owner, name of file, when file created, etc. The “Photographic” vocabulary could include information such as image size, number of pixels, lighting, etc. Optionally, the user can select “Other” to create his own vocabulary. The context menu 702 illustrates an example sub-menu for the “Search” service. This sub-menu displays some metadata vocabularies available for searching the metadata for the image. The list includes “By Creator”, “By Aircraft”, “By Corporation”, “By Location”, and “Custom”. Optionally, the web page context can be used to identify more relevant vocabularies.

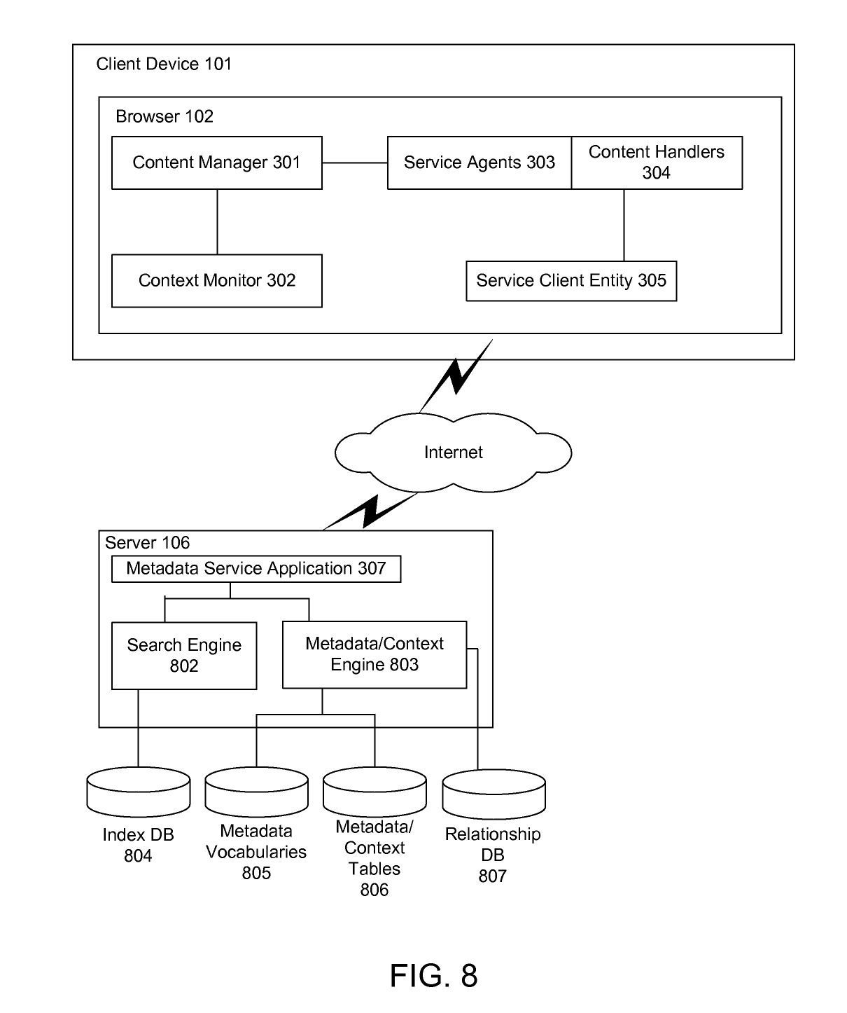

FIG. 8 illustrates an embodiment of a system for providing the metadata service. Here, the metadata service need not be associated with a source of the multimedia object, e.g., a location, such as a website, where the multimedia object is stored or hosted. In this system, the service agent 303 parses an object and examines a web page to see if other information about the object is available. The service agent 303 can request context information from the context monitor 302 and automatically populate the metadata for the image or resource with which the service agent 303 is responsible. The available metadata vocabularies for the image can then be displayed to the user in any number of ways, such as part of the context menu for the image. The user can then select a metadata vocabulary for viewing, modifying, or searching the metadata for the image. If the user provides data using the selected vocabulary, this data is stored as part of the metadata for the image. The metadata vocabularies available or the image is determined based on the object's type or identifier. The metadata vocabulary can be identified using a plurality of metadata services including a second metadata service associated with the source of the object. The metadata services associated and not associated with the source of the object are selectable from any of a plurality of metadata services. Any metadata collected is stored in a repository separate from the object, and the object is linked to the stored metadata using the object's identifier.

The service agents 303 communicate with the server 106 through the service client entity 305. The metadata service application 307 includes a search engine 802 and a metadata/context engine 803. The metadata service application 307 uses vocabulary terms to perform the search of the metadata for the image, and uses the indexes for text that's stored in an index database 804. The metadata/context engine 803 is responsible for managing metadata vocabularies, tables, and their relationships to each other. This information is stored in a metadata vocabulary database 805, metadata/context tables 806, and a relationship database 807.

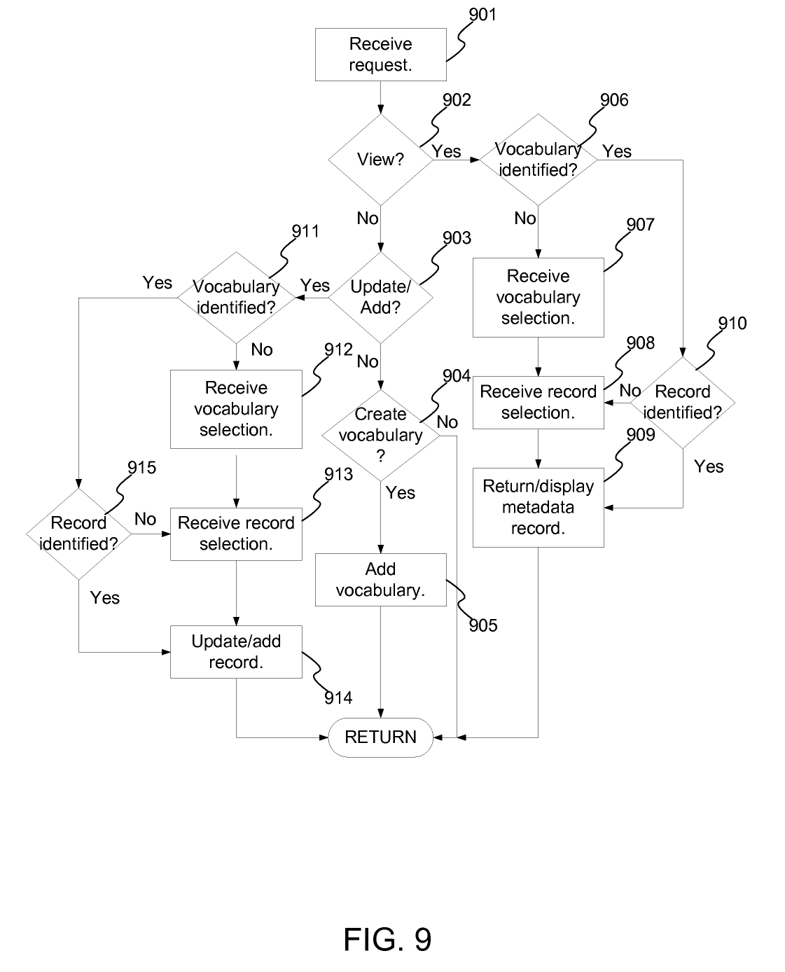

FIG. 9 is a flowchart illustrating an embodiment of a method for providing the metadata service. First, the metadata service application 307 receives a service request, via step 901. If the request is to view metadata information, via step 902, then it is determined if the metadata vocabulary is identified, via step 906. If the vocabulary is identified, then the metadata service application 307 searches for the record in the metadata context tables 806 associated with the resource for the vocabulary, via step 910. If the record is identified, then the metadata in the record is returned and displayed, via step 909. If not, then the appropriate vocabulary is determined and identified based on contextual information. The record associated with the resource for the vocabulary is then selected, via step 908, and the metadata in the record is returned and displayed, via step 909.

If the vocabulary is not identified, via step 906, then a vocabulary is selected. The selection can be based on contextual information or the user can be prompted to select a vocabulary. Once the vocabulary selection is received, via step 907, the record associated with the resource for the vocabulary is selected, via step 908, and the metadata in the record is returned and displayed, via step 909.

If the request is to update or add to existing metadata, via step 903, then it is determined if the vocabulary is identified, via step 911. If it is, then the record associated with the resource for the vocabulary is identified, via step 915, and the metadata is updated and added, via step 914. If the record cannot be identified, then the appropriate vocabulary is determined and identified based on contextual information. The record associated with the resource for the vocabulary is then selected, via step 913, and the metadata in the record is updated or added, via step 914.

If the vocabulary is not identified, via step 911, then a vocabulary is selected, via step 912. The selection can be based on contextual information or the user can be prompted to select a vocabulary. Once the vocabulary selection is received, the record associated with the resource for the vocabulary is selected, via step 913, and the metadata in the record is updated or added, via step 914.

If the request is to create a vocabulary, via step 904, then the vocabulary is added to the metadata vocabulary database 805, via step 905. The vocabulary can be created from an existing vocabulary. The creating of a vocabulary is described in co-pending U.S. patent application entitled, “Specifying, Assigning, and Maintaining User Defined Metadata in a Network-Based Photosharing System”, Ser. No. 10/034,277, filed on Dec. 28, 2001, and assigned to the assignee of the present application. This patent application is hereby incorporated by reference in its entirety.

The illustrated process can be optimized to prevent unneeded updates of the metadata. For example, a timestamp of the last update and a record of changes since the last update can be maintained. Image processing can also be performed on a service to identify duplicates and altered copies. Optionally, usage tracking and copyright infringement detection can be provided as part of a service, where possible duplicate copies are identified through image analysis and metadata analysis. Further, other options can be provided. For example, multiple service URL's and/or multiple services can be provided to allow interoperability to create a distributed repository; user's can be allowed to register new services for an image a set of images that meet specified matching criteria where the criteria can include metadata and/or image data; a server could provide the service URL as part of the web page markup; and the process can be extended to any addressable item on the web (movies, audios, documents of various types, web pages and portions of web pages, photo albums, user groups, etc.).

For example, Joe Audio and friends create a web site with articles on jazz music. The site also has reviews, history, forums, etc. Some of the information is in a database, so the page content is generated on the fly. No metadata is provided for the songs, images, movies, and text objects served by their site.

Annabel discovers Joe's site through a search engine. She views a page which provides a link to an audio stream of a song, the lyrics of which were written by her grandfather. Annabel right clicks on the page to bring up the context menu, which includes “Provide more info”. She selects the “Provide more info” service, and the browser shows the title of the page and URL of the page she wants to provide more information about. It provides various links, such as links to see information already available for the page, links for words on the page (such as “song” or “artist”), and links for providing information (such as “song writer” or “song history”). There is an indicator next to the “song writer” link to indicate that data has already been provided for that link. She selects it and sees entries for her grandfather's last name, his nationality, but the other entries are blank. Annabel provides her grandfather's full name and stage name, among other information which are then added to the metadata for the song. She wants to share more information so she selects the “add more data” service from the context menu. She is then taken to a search page to search for a vocabulary that fits what she wants to enter. She enters “family” and is presented with vocabularies related to family history, personal history, family tree, etc. She selects the family history vocabulary. She is taken through a series of forms where she describes her grandfather's personal history. She comes back another day to fill-in data related to other vocabularies. At that time, she can also return to Joe's web site and right clicks on the audio file link for the song to see what information has been collected for the song. The collected information would include Annabel's information about her grandfather provided along side information provided by others. Annabel can be given the option to provide feedback about Joe's website. This feedback would then be stored as metadata and can be provided to Joe for a fee.

Visitors to the site can certify themselves. Others can score them for relevance and accuracy. Although illustrated with a browser, web services can be provided so that non-browser applications can use the service without departing from the spirit and scope of the present invention. For example, a desktop imaging application, such as PHOTOSHOP from Adobe System, Inc., could use the service URL in an image to make services associated with the image available through PHOTOSHOP's user interface. PHOTOSHOP may add its own service URL to each image it processes, so that services associated with PHOTOSHOP are available for each image when they are loaded by a browser or other application that is compatible with the service URL system.

When a service lock is used to access the service description in a service profile, a messaging protocol is used. For example, Vivien O'Hara uses her search engine to find a Web site that is devoted to Margaret Mitchell, the author of “Gone with the Wind,” a wonderful novel that she just finished reading on her laptop while waiting for a flight from Raleigh to London that's been delayed five hours. When the author's Web site is loaded, a home page toolbar appears and buttons on it are updated. Some buttons are added, some are removed, and some remain.

The site is full of information about the author in the form of HTML pages with embedded images and links. The home page has objects to take Vivien to information about Ms. Mitchell's books, reviews, biographical information, Pulitzer Prize, and a movie made of the book she just finished reading. As she moves her mouse across the page, object toolbars appear and disappear depending on which object in the page is underneath her mouse pointer. Some of the toolbars have a copyright button labeled “©,” and when she selects it, a copyright statement is displayed with a warning that the object may be unauthorized.

She pauses over an image advertising the movie of “Gone with the Wind.” Surprised the novel was made into a movie, she looks at the toolbar and sees a button that reads “Movie.” She selects that button and a new page opens with various icons to take her to pages that describe how the movie was made, its cast members, its reviews, its Oscars, the history of the Civil War, and ways to purchase or view the movie. She moves her mouse pointer to an image of the movie's poster, labeled “Watch the movie.” Its toolbar updates with buttons for “Amazon,” “Netflix,” “View Online,” “Download,” “Raleigh Theaters,” “Raleigh Blockbuster,” and “Pay-per-View.”

Hoping to purchase and reserve tickets so she can see the movie when she returns from London, she goes to the “Raleigh Theaters” page and finds that the movie is no longer playing locally. Looking at her laptop clock, she sees she has plenty of time, so she returns to the “Movie” page and clicks the “View Online” button. This opens a site with a video stream to the film where she pays for the movie through PayPal and watches it on her laptop while she waits for her flight.

Four hours later, as the final movie credits scroll to an end, Vivien looks at her clock and she sees she still has some time, so she decides to read more about this phenomenal author. She selects “Biography” from the toolbar, and is taken to a Wikipedia page that tells her all about the author's life. There she is saddened to see that the toolbar has a button labeled “Obituary.” She selects that button and is taken to the NY Times archives where she reads the announcement of Ms. Mitchell death from injuries when she was hit by a car in Atlanta in 1949. Vivien's astonishment is broken when she hears her flight to London called, so she quickly uses the toolbars to purchase and download the movie from Direct2Drive, gathers up her crumpled Kleenexes, shuts down her laptop, and boards her plane. Once aloft, she opens her laptop and watches the movie again during her flight over the Atlantic.

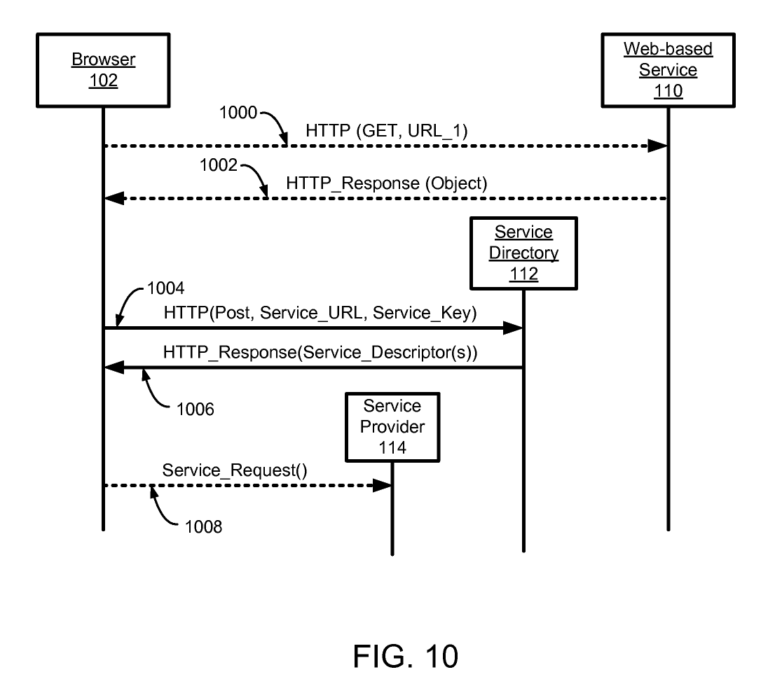

FIG. 10 illustrates the flow of messages in accessing a service specified in a service profile. Message 1000 is a typical HTTP GET command shown as an example of a browser request to a Web service 110 to retrieve a Web page or other URL-accessible object. The URL included in message 100 is shown as “URL_1.” Note that other protocols may be used such as extensible messaging and presence protocol (XMPP), presence protocols, service access protocol (SAP), simple object access protocol (SOAP), and the like. Message 1002 is the Web service's response to the HTTP GET command. This response can include a Web page, an image to be presented in a Web page, an audio or video stream for playing in a media player, or any URL-accessible object. The browser 102 detects the content in response messages, the MIME-type of the content, and then presents the content.

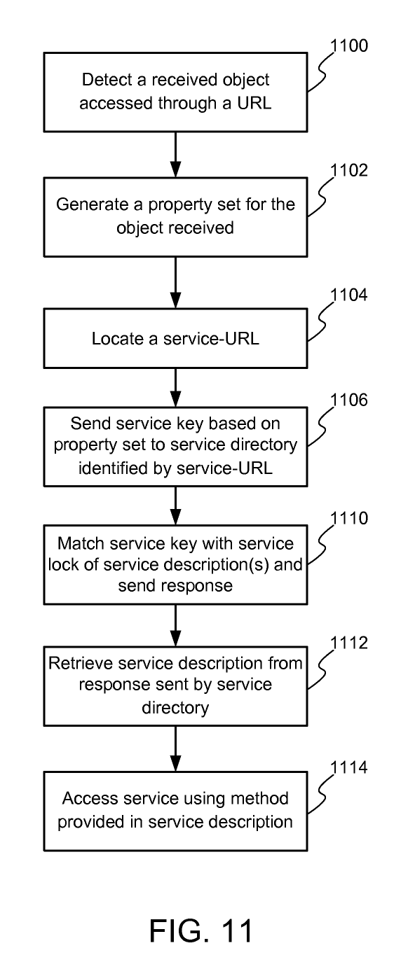

Turning to FIG. 11, the browser 102 performs additional actions when a service lock is used. The browser detects a received object accessed through a URL, such as “URL_1” depicted in FIG. 10 in block 1100.

The browser generates a property set for the object received in block 1102. An object property is an entity accessible to the browser that helps identify a service that is relevant in the context of an object received by the browser. In an embodiment, a small set of properties and a simple schema to format a property set is used.

The browser locates a service-URL in block 1104. The service-URL is used to access a service directory. A service-URL may be a part of a browser's configuration or provided with a URL-accessible object. Other methods for setting obtaining an service-URL include receiving a service-URL in a received Web page or other URL-accessible object and receiving a service-URL from a configuration service, such as a dynamic host configuration protocol (DHCP) service.

In scenario above, when Vivien O'Hara accesses the movie on the Web, the properties that are used are the object's MIME-type and source URL. Both of these properties are currently detected by browsers, so using them requires no new property detection code for the browser.

Object properties may be specified as key value pairs with an XML format that is defined by a simple schema. Example 1 illustrates a valid service-key generated from the property set for the “Gone with the Wind'” video stream. It specifies the “TYPE” of the object as a MIME type and specifies the “SOURCE” of an object as the URL used to retrieve it. A service-key message can be sent to a service-directory using an available service-URL.

```
<s-key>
  <key-value>
    <key>TYPE</key>
    <value>video/avi</value>
  </key-value>
  <key-value>
    <key>SOURCE</key>
    <value>http://watch.online/stream/gwtw.avi</value>
  </key-value>
</s-key>
```

### EXAMPLE 1

The browser sends a message 1004 that includes the service key, such as the service-key illustrated above in Example 1, to the service directory 112 identified by the service-URL in block 1106.

The service directory 112 receives the service key in message 1004 and uses the service key to locate services with matching service locks and sends a response message 1006 that includes a service description of a service profile that is matched in block 1110.

Typically, the lock and key are matched by mirroring each other. In order to access a service specified in the service profile, each value in the service key must match the corresponding key value in the service lock. Regular expressions may be used in service locks as illustrated herein. In Example 2, any object will unlock the service lock if the service key indicates that the object TYPE is an image and that it includes source URL with an HTTP scheme identifier. Otherwise, the set of services in the service profile are not available to the object.

```
<s-lock>
  <key-value>
    <key>TYPE</key>
    <value>image/.+</value>
  </key-value>
  <key-value>
    <key>SOURCE</key>
    <value>http://.+</value>
  </key-value>
</s-lock>
```

### EXAMPLE 2

A service profile includes one or more service descriptions, and each allows a service to be identified by the browser, presented to the user, and accessed in the context of the object that unlocked the service lock of the service's service profile.

The browser retrieves one or more service descriptions from the response sent by the service directory in block 1112. Example 3 shows a service description that is formatted for transmission in a message for a single service, which is the video stream service used by Vivien O'Hara in the scenario above. The service description includes a label and a reference to an image used in presenting a toolbar button, context menu item, or other user interface control. Description elements also support user help, such as help flyover text, and include information that tells the browser how to access a service when indicated.

```
<service-description>
  <service>
    <label>Watch online ...</label>
    <icon>http://watch.online/wmv/icons/moviesvc.gif</icon>
    <description>Watch this movie.</description>
    <access ><template><url>
      http://watch.online/wmv/tag?cmd=add&id=”%source%
    </url> </template></access>
  </service >
</service-description >
```

### EXAMPLE 3

Note that service key requests and service description responses may be more sophisticated as additional properties are made accessible to a browser. For example, service key requests and service description responses can be direct properties of a received object, properties generated from information inside the message that delivered the object, properties generated from objects received with the object (e.g, a web page that includes an image received), properties generated from user activities detected in the context of an object (e.g., whether or not a user has seen, clicked, or downloaded a particular object), etc. Techniques can be implemented in collecting contextual properties of a browser and browsing activities for use in service keys.

The service(s) described in the service description are accessed using the method(s) provided in the service description in block 1114. In an embodiment, a service control widget is constructed based on the service-description. The service control widget is presented by the browser in the context of the presented object. When indicated by the service control widget, the service is accessed using the method specified in the service description as illustrated by message 1008 sent to a service provider 114.

For example, Vivien O'Hara's browser received a service URL from her ISP (Internet Service Provider). In the context of FIG. 10, the Web page that includes the movie is retrieved by her browser by messages 1000 and 1002. Her browser then generates a service key based on the MIME-type of the video and its source URL. The service key is sent to the service directory identified by the service URL in message 1004, and the service directory locates a service lock that is unlocked by the service key received in message 1004. The service directory then returns the service descriptions included in the service profile of the opened service lock, as depicted by message 1006.

Vivien's browser receives the message 1006 and associates the service descriptions with the movie. When her mouse pointer is over the video stream object, her browser presents the toolbar, which includes buttons for accessing the services specified in the received service descriptions.

When she selects the toolbar's online viewing button generated from the service description for the movie services, the browser fills the URL template's “% SOURCE %” variable with the URL of the video stream. The browser then accesses the online movie service by sending a command depicted as message 1008 in FIG. 10 to “watch.online” as identified in the access URL in the service description (see Example 3).

The response that is received is processed the way that browsers typically process responses. That is, the movie is presented in a Web page that allows Vivien to access and watch it in the context of the video stream.

A method and system for automatically creating a metadata repository for multimedia objects have been disclosed. The method and system includes a service URL in the metadata associated with a multimedia object. The service URL is used by a browser to access a service profile application to retrieve a service profile. The service profile describes the services available to the multimedia object how to invoke these services. One of the services that can be provided is a metadata service that allows users to view, modify, or search the metadata for the multimedia object. In this manner, a common mechanism for providing information related to the multimedia object and for providing or advertising services related to the object is provided.

It should be understood that the various system components (and means) defined by the claims and illustrated in the various block diagrams represent logical components that are configured to perform the functionality described herein. While at least one of these components are implemented at least partially as an electronic hardware component, and therefore constitutes a machine, the other components may be implemented in software, hardware, or a combination of the two. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of the two. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

Moreover, the methods described herein can be embodied in executable instructions stored in a computer readable medium for use by or in connection with an instruction execution machine, apparatus, or device, such as a computer-based or processor-containing machine, apparatus, or device. As used here, a “computer-readable medium” can include one or more of any suitable media for storing the executable instructions of a computer program in one or more of an electronic, magnetic, optical, and electromagnetic, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

The use of the terms “a” and “an” and “the” and similar referents in the context of describing the subject matter (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illuminate the subject matter and does not pose a limitation on the scope of the subject matter unless otherwise claimed. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for providing access to a service associated with a resource, comprising:
receiving a resource accessed via a Uniform Resource Identifier (URI);
generating a service key based on an attribute of the resource;
locating service access information for accessing a service associated with the resource based on the service key matching a service lock for accessing the service;
generating a service access message, identifying the resource, based on the service access information; and
sending the service access message for accessing the service,
wherein at least one of the preceding actions is performed on at least one electronic hardware component.

2. The method of claim 1 further comprising presenting a response from a remote service.

3. The method of claim 1 wherein generating the service key comprises generating a set of attribute values associated with the resource.

4. The method of claim 3 wherein the set of attribute values includes at least one of a MIME type of the resource, a size of the resource, and the URL of the resource.

5. The method of claim 1 further comprising presenting the resource and a service control for accessing the remote service.

6. The method of claim 5 further comprising receiving an input corresponding to the service control.

7. The method of claim 5 wherein presenting the service control includes constructing the service control based upon the service access information.

8. The method of claim 1 wherein locating the service access information comprises sending the service key to a service directory for matching the service key with a service lock and receiving access to at least one service description in a service profile in response to the service key matching a service lock.

9. A method for providing access to a service associated with a resource, comprising:
receiving service access information for accessing a service associated with a resource;
associating with the service access information a service lock specifying a matching criterion;
receiving a service key including an attribute of the resource;
determining that the service key matches the service lock based on the attribute and the matching criterion; and
in response to the service key matching the service lock, sending the service access information for providing to a client for accessing the service when provided with access to the resource,
wherein at least one of the preceding actions is performed on at least one electronic hardware component.

10. The method of claim 9 wherein the attribute of the resource includes at least one of a MIME type of the resource, a size of the resource, and the URL of the resource.

11. The method of claim 9 wherein the service lock and the service key are mirrors of each other.

12. The method of claim 9 wherein determining that the service key matches the service lock comprises determining that each value in the service key matches a corresponding key value in the service lock.

13. A method for providing access to a service associated with a resource, comprising:
generating a service lock identifying a matching criterion for associating a service with a resource;
generating service access information for accessing a service by an accessor of the resource;
providing the service lock and the service access information to a service directory for providing the service access information to an accessor of the resource based on matching the service lock;
receiving a request to access the service from the accessor based on the service access information; and
providing access to the service in response to receiving the request,
wherein at least one of the preceding actions is performed on at least one electronic hardware component.

14. The method of claim 13 wherein the service lock comprises at least one value of an attribute to be matched by the accessor.

15. The method of claim 14 wherein the attribute includes at least one of a MIME type of the resource, a size of the resource, and the URL of the resource.

16. The method of claim 13 wherein the service access information comprises at least one service description in a service profile.

17. A computer readable medium storing a computer program, executable by a machine, for providing access to a service associated with a resource, the computer program comprising executable instructions for:
receiving a resource accessed via a Uniform Resource Identifier (URI);
generating a service key based on an attribute of the resource;
locating service access information for accessing a service associated with the resource based on the service key matching a service lock for accessing the service;
generating a service access message, identifying the resource, based on the service access information; and
sending the service access message for accessing the service.

18. The computer readable medium of claim 17 having further executable instructions for presenting a response from the remote service.

19. The computer readable medium of claim 17 wherein generating the service key comprises generating a set of attribute values associated with the resource.

20. The computer readable medium of claim 19 wherein the set of attribute values includes at least one of a MIME type of the resource, a size of the resource, and the URL of the resource.

21. The computer readable medium of claim 17 having further executable instructions for presenting the resource and a service control for accessing the remote service.

22. The computer readable medium of claim 21 having further executable instructions for receiving an input corresponding to the service control.

23. The computer readable medium of claim 21 wherein presenting the service control includes constructing the service control based upon the service access information.

24. The computer readable medium of claim 17 wherein locating the service access information comprises sending the service key to a service directory for matching the service key with a service lock and receiving access to at least one service description in a service profile in response to the service key matching a service lock.

25. A computer readable medium storing a computer program, executable by a machine, for providing access to a service associated with a resource, the computer program comprising executable instructions for:
receiving service access information for accessing a service associated with a resource;
associating with the service access information a service lock specifying a matching criterion;
receiving a service key including an attribute of the resource;
determining that the service key matches the service lock based on the attribute and the matching criterion; and
in response to the service key matching the service lock, sending the service access information for providing to a client for accessing the service when provided with access to the resource.

26. The computer readable medium of claim 25 wherein the attribute of the resource includes at least one of a MIME type of the resource, a size of the resource, and the URL of the resource.

27. The computer readable medium of claim 25 wherein the service lock and the service key are mirrors of each other.

28. The computer readable medium of claim 25 wherein determining that the service key matches the service lock comprises determining that each value in the service key matches a corresponding key value in the service lock.

29. A computer readable medium storing a computer program, executable by a machine, for providing access to a service associated with a resource, the computer program comprising executable instructions for:
generating a service lock identifying a matching criterion for associating a service with a resource;
generating service access information for accessing a service by an accessor of the resource;
providing the service lock and the service access information to a service directory for providing the service access information to an accessor of the resource based on matching the service lock;
receiving a request to access the service from the accessor based on the service access information; and
providing access to the service in response to receiving the request.

30. The computer readable medium of claim 29 wherein the service lock comprises at least one value of an attribute to be matched by the accessor.

31. The computer readable medium of claim 30 wherein the attribute includes at least one of a MIME type of the resource, a size of the resource, and the URL of the resource.

32. The computer readable medium of claim 29 wherein the service access information comprises at least one service description in a service profile.

33. A method for providing a metadata service for multimedia objects, comprising:
receiving a service request for the metadata service for a multimedia object having a source not associated with the metadata service, wherein at least one metadata vocabulary available for the multimedia object can be identified and displayed to provide data according to the metadata vocabulary;
processing the service request by a metadata service application; and
returning a service response by the metadata service application,
wherein at least one of the preceding actions is performed on at least one electronic hardware component.

34. The method of claim 33 wherein the service request has a service key, processing the service request includes determining that the service key matches a service lock, the service specifying a matching criterion and returning the service response comprises returning the service response in response to the service key matching the service lock.

35. A method for providing access to a service associated with a resource, comprising:
receiving a resource accessed via a Uniform Resource Identifier (URI);
locating a service directory URI for accessing service information for the resource;
generating a service key based on an attribute of the resource;
sending a service request message having the service key to a service directory identified via the service directory URI;
receiving a service directory response message including service access information for accessing a service associated with the resource based on the service key matching a service lock for accessing the service;
generating a service access message, identifying the resource, based on the service access information; and
sending the service access message for accessing the service,
wherein at least one of the preceding actions is performed on at least one electronic hardware component.

36. The method of claim 35 further comprising presenting a response from a remote service.

37. The method of claim 35 wherein generating the service key comprises generating a set of attribute values associated with the resource.

38. The method of claim 37 wherein the set of attribute values includes at least one of a MIME type of the resource, a size of the resource, and the URL of the resource.

39. The method of claim 35 further comprising presenting the resource and a service control for accessing the remote service.

40. The method of claim 39 further comprising receiving an input corresponding to the service control.

41. The method of claim 39 wherein presenting the service control includes constructing the service control based upon the service access information.
